(19) United States
(12) Patent Application Publication
(10) Pub. No.: US 2005/0123834 A1
(43) Pub. Date: Jun. 9, 2005

(54) Secondary battery

(75) Inventors: Takehiro Noguchi, Tokyo (JP); Ikiko Yamazaki, Tokyo (JP); Daisuke Kawasaki, Tokyo (JP); Tatsuji Numata, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/725,941

(22) Filed: Dec. 3, 2003

(51) Int. Cl. H01M 10/40; H01M 4/50; H01M 4/52

(52) U.S. Cl. 429/326; 429/332; 429/224; 429/223; 429/231.1

(57) ABSTRACT

A cathode active material having an average discharge potential of 4.5 V or more with respect to Li metal is used, and as an electrolyte, a solvent with higher dielectric constant such as ethylene carbonate, and at least one of dimethyl carbonate and ethylmethyl carbonate are used in combination. A higher operating voltage can be realized while suppressing capacity reduction after cycles and reduction of reliability at a higher temperature.

### TECHNICAL FIELD

The present invention relates to a secondary battery, and more specifically relates to the secondary battery including a cathode active material having an average discharge potential of 4.5 V or more with respect to Li metal.

### BACKGROUND ART

A lithium ion secondary battery is extensively utilized in such a usage as portable electronic devices and personal computers, and also will be expected to be applied to vehicles. While the miniaturization and the lightness of the battery are conventionally required in these usages, the increase of the energy density of the battery is an important technical problem to be solved.

Several methods of increasing the energy density of the lithium ion secondary battery have been devised, and among these, the increase of an operating voltage is an effective means. The operating voltages in the conventional lithium ion secondary batteries using a cathode active material such as lithium cobalt (LiCoO₂) and lithium manganese oxide (LiMn₂O₄) is 4V-class (average operating voltage is from 3.6 to 3.8 V with respect to the voltage of lithium metal). This is because a generation potential is prescribed by the redox reaction of Co ion or Mn ion (Co³⁺ [symbol] Co⁴⁺ or Mn³⁺ [symbol] Mn⁴⁺). On the other hand, the realization of the 5V-class operating voltage is known by using, as the active material, the spinel-type compound in which the Mn in the lithium manganese oxide is replaced with Ni. Specifically, the use of spinel compounds such as LiNi_{0.5}Mn_{1.5}O₄ is known to produce a potential plateau in a range of 4.5 V or more (J. Electrochem. Soc. vol. 144 (1997)). In this spinel compound, the Mn exists in the tetra-valency state, and the redox reaction Ni²⁺ [symbol] Ni⁴⁺ prescribes the operating voltage in place of the redox reaction of Mn³⁺ [symbol] Mn⁴⁺.

However, in a battery using a cathode material of 5V-class such as LiNi_{0.5}Mn_{1.5}O₄ as an active material, the cathode potential is higher than that of the battery using the 4V-class active material such as LiCoO₂ and LiMn₂O₄ so that a decomposition reaction of an electrolyte takes place to generate the severe deterioration of the electrolyte accompanied with the capacity reduction in a charge-discharge cycle or in a charged state without being attended. Further, the above phenomenon becomes notably in the operation under a high temperature circumstance such as 50° C.

In a battery using a 5V-class spinel-type lithium-manganese composite oxide as a cathode and amorphous carbon as an anode, a problem arises that the decomposition product of the electrolyte is accumulated on the anode surface to reduce its capacity.

### DISCLOSURE OF INVENTION

In view of the above circumstance, an object of the present invention is to provide a secondary battery realizing a higher operating voltage while suppressing capacity reduction after cycles and reliability reduction at a higher temperature. The object of the present invention can be attained by improving the capacity reduction generated in the battery using a 5V-class spinel-type lithium-manganese composite oxide as a cathode and amorphous carbon as an anode.

The present invention provides the secondary battery including a cathode active material having an average discharge potential of 4.5 V or more with respect to Li metal and an electrolyte in which the electrolyte contains a high-permittivity solvent having a dielectric constant (component “a”) and another solvent (component “b”) having at least one of dimethyl carbonate and ethylmethyl carbonate.

As described, the deterioration of the electrolyte due to the higher voltage in the battery has become prominent in the secondary battery including the 5V-class cathode active material. The diligent investigation by our inventors has revealed that the electrolyte with excellent durability can be realized with little deterioration under the higher voltage conditions when the above solvents for forming the electrolyte are selected.

The reduction of the decomposition reaction of the electrolyte in the secondary battery of the present invention decreases an amount of the decomposition product of the electrolyte. Accordingly, the accumulation of the decomposition product can be suppressed which causes the capacity reduction after the cycles can be suppressed.

The dimethyl carbonate and the ethylmethyl carbonate are supposed to form a film on the anode surface at the initial charge-discharge stage thereby suppressing the deposition of the decomposition product on the anode surface. “The high-permittivity solvent” in the present specification refers to a solvent having a specific dielectric constant of 40 or more such as ethylene carbonate, propylene carbonate and butylene carbonate.

JP-A-2000-133263 and 2001-357848 disclose secondary batteries using a cathode active material and a mixed solvent containing ethylene carbonate and dimethyl carbonate as an electrolyte wherein spinel-type lithium manganate in which part of the Mn therein is replaced with another element such as Al is used as the cathode active material. However, this technique relates to the battery using the 4V-class cathode active material which is essentially different from the present invention using the 5V-class active material. The description with respect thereto will be presented.

The 4V-class spinel-type lithium manganese and the compound in which part of the Mn therein is replaced with another element such as Al disclosed in the above publications essentially contain Mn³⁺ for utilizing a redox reaction of Mn³⁺ [symbol] Mn⁴⁺ so that the existence of the Mn³⁺ is essential.

The Mn³⁺ generates Mn²⁺ in accordance with the following reaction.
2Mn³⁺ [symbol] Mn²⁺+Mn⁴⁺

Since the Mn²⁺ generated in this manner is dissolved into the electrolyte, the suppression of the Mn elution is an important subject when the above cathode active material is used.

In the 4V-class cathode active material containing the Mn³⁺, the Jahn-Teller distortion is generated in the crystals during the change of the average valency of the Mn ion between trivalent and tetravalent to lower the stability of the crystalline structure so that the capacity deterioration after the cycles may occur.

In order to solve these problems, the above publications propose to adjust the composition of the cathode active material or to adjust the conditions for preparing the active material layer.

On the other hand, in the present invention using the 5V-class cathode active material, the Mn elution and the stability reduction of the crystalline structure generating in the 4V-class spinel-type lithium manganate are insignificant, and the decomposition of the electrolyte when a higher electric field is applied is rather significant. In the battery using the 5V-class active material, the higher redox potential such as Ni²⁺ [symbol] Ni⁴⁺ and Co³⁺ [symbol] Co⁴⁺ is primarily utilized rather than the redox potential of Mn³⁺ [symbol] Mn⁴⁺. Accordingly, most of the Mn in the cathode active material exists in the form of the Mn⁴⁺, and ordinarily only a small amount of the Mn³⁺ exists. Accordingly, the Mn elution and the stability reduction of the crystalline structure generating in the 4V-class spinel-type lithium manganate are less significant in the present invention, and the prevention of the electrolyte deterioration raised through a separate mechanism is an important technical problem.

The present invention solves these problems to suppress the electrolyte deterioration occurring due to the higher temperature in the battery. Although the interaction between the active material and the electrolyte may appear depending on the selection of the cathode active material and the anode active material thereby yielding the electrolyte deterioration, such electrolyte deterioration can be efficiently suppressed in accordance with the present invention. That is, the present invention solves the specific problem in connection with the 5V-lylel cathode active material to provide the battery having a higher battery voltage and a longer life.

The secondary battery may further include the anode active material containing amorphous carbon.

The use of the amorphous carbon as the anode active material further reduces the accumulation of the decomposition product on the anode surface so that the cycle performance is further elevated.

In a preferred embodiment of the secondary battery of the present invention, the volume ratio of the component “a” with respect to the electrolyte is in a range from 10 to 70%.

The component “b” is preferably a solvent having a lower specific dielectric constant reverse from the component “a”. A mixture containing dimethyl carbonate (:3.1) and ethylmetyl carbonate (:2.9) is exemplified. Generally, a solvent with a higher dielectric constant has higher viscosity and a solvent with a lower dielectric constant has lower viscosity. In the present invention, the specific dielectric constant and the viscosity of the whole electrolyte are moderately maintained by keeping the volume ratio of the component “a” in the above range. Thereby, the accumulation of the decomposition product on the anode surface can be further suppressed while the electric conductivity of the electrolyte is assured.

The high-permittivity solvent in the secondary battery may be ethylene carbonate or propylene carbonate. The selection of the high-permittivity solvent realizes the secondary battery having the excellent cycle performance.

The cathode active material in the secondary battery may be a spinel-type lithium-manganese composite oxide. This configuration can provide the secondary battery having the high and stable operating voltage and the high capacity.

The spinel-type lithium-manganese composite oxide in the secondary battery may be an oxide designated by the following general formula (I).
Liₐ(NiₓMn_{2-x-yM}_{y})(O_{4-w}Z_{w}) (I)
wherein 0.4<x<0.6, 0≦y, 0≦z, x+y<2, 0≦w≦1 and 0≦a≦1.2 are satisfied; M is at least one metal selected from the group consisting of Li, Al, Mg, TI, Si and Ge, and Z is at least one of F and Cl. The charge-discharge region of the spinel-type lithium-manganese composite oxide exists in a range from 4.5V to 4.8V with respect to the Li metal, and the discharge capacity at 4.5V or more is significantly high reaching to 110 mAh/g.

The investigation by the present inventors has revealed that the electrolyte deterioration in the battery using the spinel-type lithium-manganese composite oxide designated by the general formula (I) remarkably exceeds the deterioration generated due to the high voltage. This is probably due to the undesirable interaction between the cathode active material and the electrolyte.

The further investigation by the present inventors has revealed that when the spinel-type lithium-manganese composite oxide designated by the general formula (I), and the electrolyte containing at least one of dimethyl carbonate and ethylmethyl carbonate are used, the synergistic effect between the spinel-type lithium-manganese composite oxide designated by the general formula (I) and the electrolyte can effectively suppress the electrolyte deterioration.

Accordingly, even after many cycles, the excellent performance of the spinel-type lithium-manganese composite oxide designated by the general formula (I) can be maintained for a longer period of time.

The “y” in the general formula (I) in the secondary battery may satisfy the relation of 0<y. The “w” in the general formula (I) in the secondary battery may satisfy the relation of 0<w≦1. The crystalline structure of LiNiₓMn_{2-z}O₄ can be stabilized by replacing part of the “Mn” or the “O” with another element. The stabilization reduces the decomposition reaction of the electrolyte, and the cycle performance can be elevated because of the same reason.

In order to securing the sufficient capacity, the “y” in the general formula (I) preferably satisfies the relation of 0<y<0.3.

### BRIEF DESCRIPTION OF DRAWINGS

FIG. 1 is a sectional view of a secondary battery in accordance with one embodiment of the present invention.

### BEST MODE FOR IMPLEMENTING INVENTION

The secondary battery of the present invention includes the cathode having the lithium-containing metal composite oxide as the cathode active material and the anode having the anode active material inserting and extracting lithium. A separator is disposed between the cathode and the anode for preventing the electric contact. The cathode and the anode dipped in the electrolyte having lithium ion conductivity are sealed in a battery casing.

In the secondary battery of the present invention, the cathode active material having the average discharging potential of 4.5V or more with respect to the Li metal is used. For example, the lithium-containing metal composite oxide is preferably employed. A spinel-type lithium-manganese composite oxide designated by LiMn₁₋ₓMₓO₄ (M═Ni, Co, Cr, Cu, Fe), an olivine-type lithium-containing metal composite oxide designated by LiMPO₄ (M═Co, Ni, Fe) and an inverse spinel-type lithium-containing metal composite oxide such as LiNiVO₄ are exemplified as the lithium-containing composite oxide.

Among these cathode active materials, LiNiₓMn₂₋ₓO₄, one of the spinel-type lithium-manganese composite oxides, having a stabilized crystalline structure and a higher capacity of 130 mAh/g or more is preferably used. The composition ratio “x” of Ni in the active material is in a range from 0.4 to 0.6. Thereby, the discharge region of 4.5V or more is sufficiently secured to elevate the energy density.

The use of the LiNiₓMn₂₋ₓO₄ in which part of the Mn is replaced with Li, Al, Mg, Ti, Si, Ge as the cathode active material elevates the cycle performance. This is probably because the partial replacement of the Mn with the above element further stabilizes the crystalline structure of the active material. Therefore, an amount of the decomposition product of the electrolyte is decreased by the suppression of the electrolyte decomposition, thereby reducing the accumulation of the decomposition product on the cathode.

In the above active material in which part of “O” is replaced with F or Cl, the crystalline structure is further stabilized to realize the increased cycle performance. In a system where part of the Mn is replaced with a monovalent to trivalent element such as Li, Al and Mg, the capacity decreases with the increase of the Ni's valence and with the amount of the replacement. The replacement of “O” with halogen such as F and Cl beneficially counterbalances the increase of the Ni's valence to maintain the high capacity.

In the secondary battery of the present invention, amorphous carbon may be used as the anode active material. When the amorphous carbon is used, the accumulation of the decomposition product of the electrolyte on the anode surface can be reduced compared with use of another material such, thereby elevating the cycle performance. The amorphous carbon of the present invention refers to a carbon material having a broad scattering band with a peak from 15 to 40 degree expressed as a “2θ” value in the X-ray diffraction method using CuKα rays.

While the mixed solvent including the higher dielectric constant solvent and the lower dielectric constant solvent is used in the present invention, dimethyl carbonate (DMC) or ethylmethyl carbonate (EMC) is used as the lower dielectric constant solvent. The selection of the solvents can provide the electrolyte having the decomposition resistance under high voltage conditions and the excellent durability. Accordingly, the reduction of the amount of the decomposition product of the electrolyte can be attained to remarkably suppress the accumulation of the decomposition product on the anode surface. Thereby, the capacity reduction after the cycles can be further decreased. This is probably because, when the dimethyl carbonate or the ethylmethyl carbonate is used, a film containing a phosphate or a fluoride is formed on the anode surface to suppress the deposition of the decomposition product formed in the cathode side on the anode surface.

When the 5V-class spinel-type lithium-manganese composite oxide designated by the general formula (I) and the amorphous carbon are used as the cathode and the anode active materials, respectively, the secondary battery can be obtained having the cycle performance with the following effects (i) and (ii).

(i) When the 5V-class spinel-type lithium-manganese composite oxide designated by the general formula (I) is used as the cathode active material, and the electrolyte containing the DMC or the EMC is used, the active material produces the synergic effect with the DMC or the EMC to significantly reduce the absolute amount of the decomposition product of the electrolyte.

(ii) The synergistic effect between the amorphous carbon and the DMC or the EMC effectively suppresses the accumulation of the decomposition product of the electrolyte of which the absolute amount is small, on the anode surface made of the amorphous carbon.

When the electrolyte containing the DMC or the EMC is used in the secondary battery using the 4V-class cathode active material, the above effects do not appear and the significant elevation of the cycle performance is not observed. The lower voltage in the secondary battery using the 4V-class cathode active material does not generate the electrolyte decomposition sufficient to affect the cycle performance. Accordingly, in the secondary battery using the 4V-class cathode active material, no remarkable difference of the cycle performance is generated between when the electrolyte containing the DMC or the EMC is used and when an electrolyte containing another lower dielectric constant solvent such as DEC is used.

The higher dielectric constant solvent such as ethylene carbonate (EC), propylene carbonate (PC), butylene carbonate (BC) and γ-butyrolactone (GBL) can be used.

The volume ratio between the higher dielectric constant solvent and the lower dielectric constant solvent is preferably in a range from 10:90 to 70:30 for securing the electric conductivity. The volume ratio in the range moderately maintains the specific dielectric constant and the viscosity of the entire electrolyte thereby securing the sufficient electric conductivity.

In order to reduce the accumulation of the decomposition product, the volume ratio between the higher dielectric constant solvent and the lower dielectric constant solvent is preferably in a range from 20:80 to 60:40 and is more preferably in a range from 30:70 to 50:50. It is conjectured that the volume ratio in the range increases the effects of preventing the adsorption of the decomposition product on the anode surface and of suppressing the decomposition reaction of the electrolyte.

Then, the operation of the lithium ion secondary battery of the present invention will be described. A voltage applied to the cathode and the anode extracts lithium ion from the cathode active material and inserts the lithium ion into the anode active material to attain the charged state. On the other hand, contrary to the charging, the electric contact of the cathode and the anode out of the battery extracts the lithium ion from the anode active material, and the lithium ion is inserted in the cathode active material to take place the discharging.

Then. a method for preparing the cathode active material will be described.

When the spinel-type lithium-manganese composite oxide is used as the cathode active material, a Li raw material which can be used for the cathode active material includes Li₂CO₃, LiOH, Li₂O and Li₂SO₄, and among these, Li₂CO₃ and LiOH are suitable. A Mn material includes various Mn oxides such as electrolytic manganese dioxide (EMD), Mn₂O₃, Mn₃O₄ and chemical manganese dioxide (CMD), and MnCO₃ and MnSO₄. A usable Ni raw material includes NiO, Ni(OH)₂, NiSO₄ and Ni(NO₃)₂. A raw material of a replacing element includes its oxide, carbonate, hydroxide, sulfide and nitrate. The element diffusion may hardly take place during the sintering in the Ni raw material, the Mn raw material and the replacing element raw material so that the Ni raw material, the Mn raw material and the replacing element raw material may remain as their hetero-phases after the sintering of the raw material. In order to prevent this occurrence, after the Ni raw material, the Mn raw material and the replacing element raw material are dissolved in an aqueous solution and mixed, the mixture of Ni and Mn and that of Ni and Mn containing the replacing element can be precipitated as their hydroxides, sulfates, carbonates or nitrates and be used as the raw material. The Ni-Mn oxide or the Ni-Mn-replacing element mixed oxide prepared by sintering the above mixtures can be also used. In these mixtures used as the raw material, the Ni, the Mn and the replacing element are well diffused at atomic levels, and the Ni and the replacing element can be easily introduced into a 16d site of the spinel structure. A halogen raw material used as the cathode active material includes a halide such as LiF and LiCl.

These raw materials are weighed and mixed such that a desired metal composition ratio is obtained. The mixing is conducted by means of pulverization by using a ball mill. The cathode active material can be obtained by sintering the mixed powder in air or in oxygen at a temperature from 600° C. to 1000° C. While the sintering temperature is desirably higher for diffusing the respective elements, oxygen deficiency is generated at an excessively higher temperature to exert ill-effect on the battery performance. Accordingly, the temperature at the final sintering step is desirably at about 500° C. to 800° C.

Also, when the olivine-type lithium-containing metal composite oxide and the inverse spinel-type lithium-containing metal composite oxide are used, the cathode active material can be obtained by mixing and diffusing the required element materials followed by the sintering as mentioned above.

A specific surface area of the obtained lithium metal composite oxide is preferably 3 m²/g or less, and more preferably 1 m²/g or less. This is because the oxide with the larger specific surface area requires a larger amount of a bonding agent and is disadvantageous in connection with the capacity density of the cathode.

The obtained cathode active material is mixed with an agent for providing electric conductivity and is formed on a current collector by using a bonding agent. Examples of the agent for providing electric conductivity include a metallic material such as Al and powders of an electrically conductive material in addition to a carbon material. The bonding agent includes polyvinylidene fluoride (PVDF). A metal thin film made of mainly Al is used as the current collector.

A preferable amount of the agent for providing electric conductivity is about from 1 to 10% in weight, and an amount of the bonding agent is also about from 1 to 10% in weight. This is because the larger ratio of the active material weight increases the capacity per unit weight. The excessively small ratio between the agent for providing electric conductivity and the bonding agent may not maintain the electric conductivity and may arise a problem in connection with the peeling-off of the electrode.

The solvent employed in the electrolyte of the present invention is described above. One solvent or two or more mixed solvents can be used selected from cyclic carbonates such as vinylene carbonate (VC); linear carbonates such as diethyl carbonate (DEC) and dipropyl carbonate (DPC); aliphatic carboxylate esters such as methyl formate, methyl acetate and ethyl propionate; γ-lactones such as γ-butyrolactone; linear ethers such as 1,2-ethoxyethane (DEE) and ethoxymethoxyethane (EME); cyclic ethers such as tetrahydrofuran and 2-methyltetrahydrofuran; and an aprotic solvent such as dimethyl sulfoxide, 1,3-dioxorane, formamide, acetamide, dimethylformamide, dioxorane, acetonitrile, propylnitrile, nitromethane, ethylmonoglyme, triesterphosphate, trimethoxymethane, dioxolane derivatives, sulphorane, methylsulphorane, 1,3-dimethyl-2-imidazolidinone, 3-methyl-2-oxazolidinone, propylene carbonate derivatives, tetrahydrofuran derivatives, ethylether, 1,3,-propane sultone, anisole, N-methylpyrrolidone and fluorinated carboxylate ester.

A lithium salt is dissolved in these organic solvents. The lithium salt includes, for example, LiPF₆, LiAsF₆, LiAlCl₄, LiClO₄, LiBF₄, LiSbF₆, LiCF₃SO₃, LiC₄F₉CO₃, LiC(CF₃SO₂)₂, LiN(CF₃SO₂)₂, LiN(C₂F₅SO₂)₂, LiB₁₀Cl₁₀, lithium lower aliphatic carboxylate, lithium chloroborate, lithium tetraphenyl borate, LiBr, LiI, LiSCN, LiCl and imides.

A polymer electrolyte can be used in place of the electrolyte. The electrolyte concentration is, for example, from 0.5 mol/liter to 1.5 mol/liter. The excessively higher concentration increases the density and the viscosity. The excessively lower concentration may reduce the electric conductivity.

A carbon material such as natural graphite and artificial graphite may be contained in the anode active material as its main component, and above all, amorphous carbon is preferably used as the main component. In this manner, the accumulation of the decomposition product of the electrolyte on the anode surface can be reduced to improve the cycle performance.

An auxiliary component which inserts and extracts lithium can be contained in the anode active material. A carbon material, Li metal, Si, Sn, Al, SiO, SnO are mixed and used as the material which inserts and extracts the lithium.

The anode active material is formed on the current collector by using the agent for providing electric conductivity and the bonding agent. Examples of the agent for providing electric conductivity include powders of an electrically conductive material in addition to a carbon material. The bonding agent includes polyvinylidene fluoride. A metal thin film made of mainly Al is used as the current collector.

The lithium secondary battery of the present invention can be fabricated by, after the cathode and the anode are stacked by sandwiching a separator or further the stacked cathode and anode are wound, accommodating the stacked cathode and anode in a battery can or sealing the same by using a flexible film made of a stacked member having synthetic resin and a metal foil in dry air or in an inactive gas atmosphere.

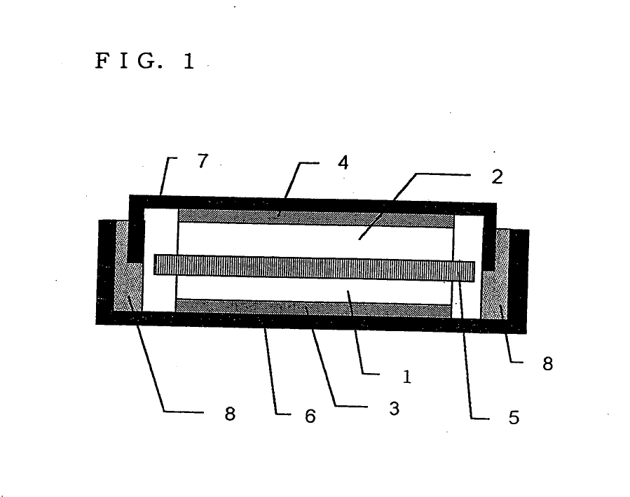

FIG. 1 shows an embodiment of a coin-type battery as an example of the battery. The battery shape of the present invention is not restricted, and the cathode and the anode opposing to each other by sandwiching the separator may be wound or stacked. The battery may be in the shape of coin, rectangular or circular cylinder, and may be in an laminated pack.

### EXAMPLES

The present invention will be hereinafter described in detail by showing Examples. In the present Examples, the coin-type battery illustrated in FIG. 1 is shown as an embodiment.

22 batteries shown in Tables 1 to 4 were fabricated in accordance with the following procedures.

Fabrication of Cathode

MnO₂, NiO, Li₂CO₃, TiO₂, SiO₂, Al₂O₃ and LiF acting as supply sources of Mn, Ni, Li, Ti, Si, Al and F. respectively, were weighed such that desired metal composition ratios were attained, and then pulverized and mixed. The LiF also acted as the supply source of the Li. Then, the powders after the raw material mixing were sintered at 750° C. for 8 hours. All the crystalline structures thus fabricated were confirmed to have spinel structures of nearly a single phase. As shown in Table 1, all the fabricated active materials had average discharge potentials of 4.5 V or more with respect to Li metal.

The thus prepared cathode active material and carbon acting as an agent for providing electric conductivity were mixed and then dispersed in N-methylpyrrolidone dissolving polyvinylidene fluoride (PVDF) as a bonding agent to prepare a slurry. The weight ratio among the cathode active material, the agent for providing electric conductivity and the bonding agent was 88:6:6. The slurry was applied on an Al current collector. Thereafter, the current collector was dried in vacuum for 12 hours to fabricate an electrode material. The electrode material was cut out to a circle having a diameter of 12 mm which was then molded at a pressure of 3 t/cm² to provide a cathode current collector 3 and a cathode active material layer 1.

Fabrication of Cathode

In case of batteries using Li metal as an anode active material, a lithium metal disc was disposed on a current collector made of Cu and cut out to a circle having a diameter of 13 mm to provide an anode current collector 4 and an anode active material layer 2.

In case of batteries using natural graphite as the anode active material, the natural graphite and carbon acting as an agent for providing electric conductivity were mixed and then dispersed in N-methylpyrrolidone dissolving polyvinylidene fluoride (PVDF) to prepare a slurry. The weight ratio among the natural graphite, the agent for providing electric conductivity and the bonding agent was 91:1:8. The slurry was applied on a Cu current collector. Thereafter, the current collector was dried in vacuum for 12 hours to fabricate an electrode material. The electrode material was cut out to a circle having a diameter of 13 mm which was then molded at a pressure of 1 t/cm² to provide the anode current collector 4 and the anode active material layer 2.

In case of batteries using amorphous carbon as the anode active material, the batteries were fabricated similarly to the above method for those using the natural graphite. Carbotron (registered trademark) P available from Kureha Chemical Industry Co., Ltd. was used as the amorphous carbon.

A polypropylene film was used as a separator 5. The cathode and the anode were opposed to each other sandwiching the separator without the electric contact and, as shown in FIG. 1, were covered with a cathode external package can 6 and an anode external package can 7. An electrolyte having a composition and a ratio (volume ratio) was filled in the package cans which were sealed by using an insulation packing 8.

LiPF₆ having a concentration of 1 mol/liter was used as a supporting salt for the electrolyte.

The cycle performances of batteries 1 to 16 thus fabricated were evaluated. For the evaluation, the charging was conducted to 4.8V at a charging rate of 1C, and discharging was then conducted to 2.5V at a rate of 1C. The “charging at a charging rate of 1C” herein refers to charging in which a numeral of a battery capacity expressed in ampere-hour is used as a value of charging current. Accordingly, for example, 0.1C refers to one-tenth of the above numeral. A test temperature was 45° C. The results were shown in Table 1.

TABLE 1

| | | Average | | | | |
|---|---|---|---|---|---|---|
| | | Discharge | | | | |
| | | Potential | | | | |
| | | of | | | Capacity | |
| | | Cathode | | | Maintenance | |
| | | Active | Solvent | | Rate | |
| | | Material | Composition | | After | After |
| | | with | and | Anode | 100 | 300 |
| | Cathode Active | respect to | Volume | Active | Cycles | Cycles |
| Battery | Material | Li Metal | Ratio | Material | at 45° C. | at 45° C. |
| 1 | LiNi_{0.5}Mn_{1.5}O₄ | 4.66 V | EC/DEC = 40/60 | Li metal | 10% | — |
| 2 | LiNi_{0.5}Mn_{1.5}O₄ | 4.66 V | EC/DEC = 40/60 | Natural | 40% | 30% |
| | | | | Graphite | | |
| 3 | LiNi_{0.5}Mn_{1.5}O₄ | 4.66 V | EC/DMC = 40/60 | Natural | 55% | 40% |
| | | | | Graphite | | |
| 4 | LiNi_{0.5}Mn_{1.5}O₄ | 4.66 V | EC/DEC = 40/60 | Amorphous | 60% | 36% |
| | | | | Carbon | | |
| 5 | LiNi_{0.5}Mn_{1.5}O₄ | 4.66 V | PC/DEC = 40/60 | Amorphous | 55% | 40% |
| | | | | Carbon | | |
| 6 | LiNi_{0.5}Mn_{1.5}O₄ | 4.66 V | PC/EMC = 40/60 | Amorphous | 65% | 45% |
| | | | | Carbon | | |
| 7 | LiNi_{0.5}Mn_{1.5}O₄ | 4.66 V | EC/EMC = 40/60 | Amorphous | 75% | 47% |
| | | | | Carbon | | |
| 8 | LiNi_{0.5}Mn_{1.5}O₄ | 4.66 V | PC/DMC = 40/60 | Amorphous | 70% | 56% |
| | | | | Carbon | | |
| 9 | LiNi_{0.5}Mn_{1.5}O₄ | 4.66 V | EC/DMC = 40/60 | Amorphous | 80% | 62% |
| | | | | Carbon | | |
| 10 | LiNi_{0.5}Mn_{1.4}Al_{0.1}O₄ | 4.65 V | EC/DMC = 40/60 | Amorphous | 84% | 64% |
| | | | | Carbon | | |
| 11 | LiNi_{0.5}Mn_{1.4}Al_{0.1}⁻ | 4.65 V | EC/DMC = 40/60 | Amorphous | 85% | 65% |
| | O_{3.9}F_{0.1} | | | Carbon | | |
| 12 | LiNi_{0.5}Mn_{1.45}Li₀₀₅O₄ | 4.65 V | EC/DMC = 40/60 | Amorphous | 82% | 64% |
| | | | | Carbon | | |
| 13 | LiNi_{0.5}Mn_{1.45}Li_{0.05}⁻ | 4.65 V | EC/DMC = 40/60 | Amorphous | 84% | 64% |
| | O_{3.85}F_{0.15} | | | Carbon | | |
| 14 | LiNi_{0.5}Mn_{1.45}Si_{0.05}O₄ | 4.65 V | EC/DMC = 40/60 | Amorphous | 84% | 65% |
| | | | | Carbon | | |
| 15 | LiNi_{0.5}Mn_{1.35}Ti_{0.15}O₄ | 4.68 V | EC/DMC = 40/60 | Amorphous | 88% | 70% |
| | | | | Carbon | | |
| 16 | LiNi_{0.5}Mn_{1.45}Ge_{0.05}O₄ | 4.64 V | EC/DMC = 40/60 | Amorphous | 87% | 68% |
| | | | | Carbon | | |

Investigation of Anode Active Material

It can be seen that the cycle reliability of the battery using the amorphous carbon as the anode is higher than that using the Li metal or the natural graphite by comparing the batteries 1, 2 and 4 in Table 1. It is also revealed that when EC/DMC was used as the electrolyte, the cycle performance of the battery using the amorphous carbon is higher than that using the natural graphite by comparing the batteries 3 and 9. Based on above, it seemed that the use of the amorphous carbon as the anode was preferable in the batteries using the 5V-class cathode active material. This is probably because the accumulation of the decomposition product of the electrolyte in the battery using the amorphous carbon is lower than that using the other materials.

Investigation of Solvent

Effects of solvents will be investigated by comparing the batteries 4 to 9 using LiNi_{0.5}Mn_{1.5}O₄ as the cathode active material, and the amorphous carbon as the anode active material.

Generally, as solvents constituting for the electrolyte, a solvent with high viscosity and high dielectric constant and a solvent with low viscosity and low dielectric constant are combined and used. In this Example, the investigation was conducted by using EC or PC as the solvent with high viscosity and high dielectric constant, and DEC, EMC or DMC as the solvent with low viscosity and low dielectric constant.

The investigation is conducted by fixing the solvent with low viscosity and low dielectric constant. When the batteries 4 and 5 (fixed to DEC), or the batteries 6 and 7 (fixed to EMC) or the batteries 8 and 9 (fixed to DMC) were compared, the cycle performance of the battery using the EC as the solvent with low viscosity and low dielectric constant was somewhat better than that using the EC, however, no distinguished difference was observed.

Then, the investigation is conducted by fixing the solvent with high viscosity and high dielectric constant to EC or PC. When the batteries 4, 7 and 9 (fixed to EC) were compared with one another, the batteries 7 and 9 using the EMC or the DMC exhibited the excellent cycle performances having capacity maintenance rates of 75% or more after 100 cycles, and the cycle performances were more excellent than that of the battery 4 using the DEC. The comparison among the batteries 5, 6 and 8 (fixed to PC) also provides similar tendency, and the batteries 6 and 8 using the EMC or the DMC exhibited more excellent cycle performances than that of the battery 5 using the DEC.

Based on the above, it is apparent that the use of the EMC or the DMC is preferable as the solvent with low viscosity and low dielectric constant.

Then, when the EMC or the DMC was used as the solvent with low viscosity and low dielectric constant in the batteries having the 4V-class cathode active material, the investigation whether or nor the above distinguished effects appeared was conducted.

Table 2 shows the cycle performances of the batteries 17 to 19 having LiMn₂O₄ as the 4V-class cathode active material and of the batteries 15, 20 and 21 having LiNi_{0.5}Mn_{1.35}Ti_{0.15}O₄ as the 5V-class cathode active material, and each battery used the solvent with low viscosity and low dielectric constant shown therein.

TABLE 2

| | | Average | | | | |
|---|---|---|---|---|---|---|
| | | Discharge | | | | |
| | | Potential | | | | |
| | | of | | | Capacity | |
| | | Cathode | | | Maintenance | |
| | | Active | Solvent | | Rate | |
| | | Material | Composition | | After | After |
| | | with | and | Anode | 300 | 500 |
| | Cathode Active | respect to | Volume | Active | Cycles | Cycles |
| Battery | Material | Li Metal | Ratio | Material | at 45° C. | at 45° C. |
| 17 | LiMn₂O₄ | 4.03 V | PC/DEC = 40/60 | Amorphous | — | 78% |
| | | | | Carbon | | |
| 18 | LiMn₂O₄ | 4.03 V | PC/EMC = 40/60 | Amorphous | — | 80% |
| | | | | Carbon | | |
| 19 | LiMn₂O₄ | 4.03 V | PC/DMC = 40/60 | Amorphous | — | 84% |
| | | | | Carbon | | |
| 20 | LiNi_{0.5}Mn_{1.35}Ti_{0.15}O₄ | 4.68 V | EC/DEC = 40/60 | Amorphous | 40% | <10% |
| | | | | Carbon | | |
| 21 | LiNi_{0.5}Mn_{1.35}Ti_{0.15}O₄ | 4.68 V | EC/EMC = 40/60 | Amorphous | 47% | 20% |
| | | | | Carbon | | |
| 15 | LiNi_{0.5}Mn_{1.35}Ti_{0.15}O₄ | 4.68 V | EC/DMC = 40/60 | Amorphous | 74% | 53% |
| | | | | Carbon | | |

When the capacity maintenance rates after 500 cycles of the batteries 17 to 19 having the 4V-class cathode active material in Table 2 are referred to, those of the batteries 18 and 19 using the EMC or the DMC as the solvent with low viscosity and low dielectric constant were excellent by about 2 to 6% compared with that of the battery 17 using the DEC. On the other hand, when the capacity maintenance rates after 500 cycles of the batteries 15, 20 and 21 having the 5V-class cathode active material are referred to, those of the batteries 15 and 21 using the EMC or the DMC were excellent by about 10 to 40% compared with that of the battery 20 using the DEC, and the remarkable effect could be observed. In connection with the batteries 15, 20 and 21, the remarkable effect generated by using the EMC and the DMC could also be observed when the capacity maintenance ratios after 300 cycles were compared.

Based on the above results, the remarkable improvement of the cycle performance could be made apparent in the battery using the 5V-class active material by using the EMC or the DMC as the solvent with low viscosity and low dielectric constant.

Then, in order to clarify a reason for preferably using the EMC or the DMC as the solvent with low viscosity and low dielectric constant, the following investigation was conducted.

In a battery of which a capacity is reduced after cycles, the difference of charge-discharge capacity values between 1C (higher rate) and 0. 1C (lower rate) is larger. This phenomenon is probably due to impedance increase in the battery.

When an amount of the increased impedance is defined to be “R” and the current value is defined to be “I”, a higher voltage by IR is required for charging the battery to the designed capacity. Since, however, the charging is stopped when the voltage reaches to a specified voltage prescribed in advance or thereafter further charging is conducted at a lower voltage for a specified period of time in the charging of the lithium ion secondary battery, the charging is stopped before the original designed capacity is fulfilled. Accordingly, with the increase of the amount of the increased impedance “R” or with the increase of the current value “I”, the charge-discharge capacity value is reduced. This phenomenon distinguishes the difference between the capacity values at the higher rate and the lower rate, with the increase of the “R”.

Table 3 shows the values of (1C charge-discharge capacity)/(0.1C charge-discharge capacity) after 300 cycles of the batteries 20, 21 and 15 using LiNi_{0.5}Mn_{1.35}Ti_{0.15}O₄ as the cathode active material, amorphous carbon as the anode active material and EC/DEC, EC/EMC or EC/DMC as the solvent.

TABLE 3

| | | | | (1 C charge- |
|---|---|---|---|---|
| | | | | discharge |
| | | Solvent | | capacity)/ |
| | | Composition | Anode | (0.1 C charge- |
| | Cathode Active | and Volume | Active | discharge |
| Battery | Material | Ratio | Material | capacity) |
| 20 | LiNi_{0.5}Mn_{1.35}Ti_{0.15}O₄ | EC/DEC = | Amor- | 60% |
| | | 40/60 | phous | |
| | | | Carbon | |
| 21 | LiNi_{0.5}Mn_{1.35}Ti_{0.15}O₄ | EC/EMC = | Amor- | 67% |
| | | 40/60 | phous | |
| | | | Carbon | |
| 15 | LiNi_{0.5}Mn_{1.35}Ti_{0.15}O₄ | EC/DMC = | Amor- | 81% |
| | | 40/60 | phous | |
| | | | Carbon | |

As shown in Table 3, the values of (1C charge-discharge capacity)/(0.1C charge-discharge capacity) after the 300 cycles are different from one another, and the value thereof of the battery 20 using the DEC is lower than those of the batteries 11 and 15 using the EMC or the DMC. Based thereon, the difference between the capacity value at the higher rate and that at the lower rate of the battery 20 is larger than the differences of the batteries 21 and 15. Accordingly, the impedance increase of the battery 20 seems further advanced with the cycles than that of the batteries 21 or 15. It is conjectured that the impedance increase is based mainly on the accumulation of the decomposition product of the electrolyte on the anode surface.

The above description can be summarized as follows. When the EMC or the DMC is used as the solvent with low viscosity and low dielectric constant, the amount of the accumulation of the decomposition product of the electrolyte on the anode surface is smaller compared with the use of the DEC. This may contribute to the improvement of the cycle performance.

In order to investigate how the volume ratio between the solvent with high viscosity and high dielectric constant and the solvent with low viscosity and low dielectric constant affects the values of the (1C charge-discharge capacity)/(0.1C charge-discharge capacity) in the batteries using the DMC, the evaluation was conducted in the batteries shown in Table 4.

TABLE 4

| | | | | | Capacity |
|---|---|---|---|---|---|
| | | Solvent | | (1 C charge-discharge | Maintenance |
| | Cathode | Composition | Anode | capacity)/ | Rate |
| | Active | and Volume | Active | (0.1 C charge-discharge | After 300 |
| Battery | Material | Ratio | Material | capacity)/ | Cycles at 45° C. |
| 9 | LiNi_{0.5}Mn_{1.5}O₄ | EC/DMC = 40/60 | Amorphous | 90% | 64% |
| | | | Carbon | | |
| 22 | LiNi_{0.5}Mn_{1.5}O₄ | EC/DMC = 50/50 | Amorphous | 86% | 70% |
| | | | Carbon | | |

The above battery 9 had the same configuration as the battery 9 shown in Table 1, and the battery 22 was the same as the battery 9 except that the volume ratio of the EC which was the solvent with high viscosity and high dielectric constant was made to be 50%.

As shown in Table 4, no distinguished difference could be observed in the values of the (1C charge-discharge capacity)/ (0.1C charge-discharge capacity) after 200 cycles of the batteries 9 and 22, and the accumulation amount of the decomposition product of the electrolyte on the anode surface after 200 cycles was suggested to be small. Further, no distinguished difference could be observed in the capacity maintenance rates after 200 cycles between the batteries 9 and 22. It was conjectured to be suitable that the volume ratio of the EC which was the solvent with high viscosity and high dielectric constant was from 40 to 50% for obtaining the excellent cycle performance.

Investigation of Cathode Active Material in Which Part of Mn is Replaced with Another Element

Again, back to Table 1, the cathode active material was investigated as follows.

The batteries 10, 12, 14, 15 and 16 used the cathode active materials in which part of Mn in LiNi_{0.5}Mn_{1.5}O₄ was replaced with Al, Li, Si, Ti and Ge, respectively. The comparison among these batteries and the battery 9 using LiNi_{0.5}Mn_{1.5}O₄ as the cathode active material clarified that the capacity maintenance rates after 100 cycles and 300 cycles could be further improved by replacing the part of the Mn in the LiNi_{0.5}Mn_{1.5}O₄ with the above elements. Among these, the battery 15 in which the part of the Mn in the LiNi_{0.5}Mn_{1.5}O₄ was replaced with the Ti was excellent in view of energy density because the battery had the significantly excellent cycle performance and the battery used the active material having the higher discharge potential with respect to Li metal than the other elements.

As described, it is conjectured that the replacement of the part of the Mn in the LiNi_{0.5}Mn_{1.5}O₄ with the above elements stabilized the crystalline structure of the cathode active material to reduce the deterioration.

Investigation of Active Material in Which Part of “O” is Replaced with “F”

The batteries 11 and 13 used the cathode active materials in which part of “O” in the active materials of the batteries 10 and 12 was replaced with “F”. The comparison between the batteries 10 and 11 or between the batteries 12 and 13 clarifies the further improvement of the cycle performance by the partial replacement of “O” with “F”.

The valence of Ni increases in a system where part of the Mn in the LiNi_{0.5}Mn_{1.5}O₄ is replaced with an element having a valence of 1 to 3. The Ni valence increase generates the instability of the crystalline structure and the capacity reduction. In the cathode active materials of the batteries 11 and 13, the instability of the crystalline structure is averted by replacing the part of the “O” with the “F” to counterbalance the Ni valence increase. Thereby, the cycle performance seems improved. The capacities of the batteries 11 and 13 are improved when compared with those of the batteries 10 and 12, respectively, because the capacity reduction can be simultaneously averted.

While the batteries using the spinel-type lithium- manganese composite oxide as the cathode active material have been described in the above examples, the effects described in the examples can be also obtained in batteries using other active materials such as the olivine-type lithium-containing metal composite oxide including, for example, LiCoPO₄ and the inverse spinel-type lithium-containing metal composite oxide including LiNiVO₄.

As described, the present invention can provide the secondary battery realizing the higher operating voltage while suppressing the capacity reduction after the cycles and the reduction of reliability at a higher temperature by using the electrolyte containing the solvent with the higher dielectric constant and at least one of the dimethyl carbonate and the ethylmethyl carbonate.

1. A secondary battery comprising a cathode active material having an average discharge potential of 4.5 V or more with respect to Li metal and an electrolyte, wherein the electrolyte includes a high-permittivity solvent having a dielectric constant of 40 or more and another solvent which is at least one of dimethyl carbonate and ethylmethyl carbonate.

2. The secondary battery as defined in claim 1 further comprising an anode active material containing amorphous carbon.

3. The secondary battery as defined in claim 1, wherein a volume ratio of the high-permittivity solvent with respect to the electrolyte is in a range from 10 to 70%.

4. The secondary battery as defined in claim 1, wherein the high-permittivity solvent is ethylene carbonate or propylene carbonate.

5. The secondary battery as defined in claim 1, wherein the cathode active material is spinel-type lithium-manganese composite oxide.

6. The secondary battery as defined in claim 5, wherein the spinel-type lithium-manganese composite oxide is represented by the following general formula (I)
Liₐ(NiₓMn_{2-x-y}M_{y})(O_{4-w}Z_{w}) (I)
wherein 0.4<x<0.6, 0≦y, 0≦z, x+y<2, 0≦w≦1 and 0≦a≦1.2 are satisfied; M is at least one metal selected from the group consisting of Li, Al, Mg, Ti, Si and Ge, and Z is at least one of F and Cl.

7. The secondary battery as defined in claim 6, wherein the “y” in the general formula (I) satisfies a relation of 0<y.

8. The secondary battery as defined in claim 6, wherein the “w” in the general formula (I) satisfies a relation of 0<w≦1.
